(19) United States
(12) Patent Application Publication
(10) Pub. No.: US 2010/0094835 A1
(43) Pub. Date: Apr. 15, 2010

(54) AUTOMATIC QUERY CONCEPTS IDENTIFICATION AND DRIFTING FOR WEB SEARCH

(76) Inventors: Yumao Lu, San Jose, CA (US); Benoit Dumoulin, Palo Alto, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/252,220

(22) Filed: Oct. 15, 2008

(51) Int. Cl. G06F 7/06; G06F 17/30; G06N 5/02

(52) U.S. Cl. 707/705; 706/52; 707/E17.108; 707/E17.143

(57) ABSTRACT

Techniques are described for automatically determining which terms in a search query may be augmented by contextually similar terms such that more relevant results can be displayed to a user. Contextually similar words are determined based on training data, including a web corpus and a query log. Once contextually similar words are determined, they may be inserted into a search query and used to find more relevant results. Consequently, documents that contain helpful information but may not have exact word matches may be found more readily by a search engine.

### FIELD OF THE INVENTION

The techniques described herein relate to presenting a user with accurate search results based on a query. In particular, the current invention involves determining which (segments or concepts/terms) of a query can be augmented with other terms that are semantically similar.

### BACKGROUND

As the amount of information available on the Internet increases, the need to filter relevant documents efficiently in response to a query becomes increasingly difficult. Accordingly, new techniques for determining relevant documents may improve the user experience. Search engines that enable computer users to obtain references to web pages that contain one or more specified words are now commonplace. Typically, a user can access a search engine by directing a web browser to a search engine “portal” web page. The portal page usually contains a text entry field and a button control. The user can initiate a search for web pages that contain specified query terms by typing those query terms into the text entry field and then activating the button control. When the button control is activated, the query terms are sent to the search engine, which typically returns, to the user's web browser, a dynamically generated web page that contains a list of references to other web pages that contain the query terms.

Delivering accurate and correct searches to a web user in response to a search query is important for a web search engine. A user's query may contain multiple concepts. The input query might not accurately represent the user's intent. Traditionally, search engines do key word matching only. By doing so, a large number of good documents which may contain slightly different concepts but still be relevant to the user's search query may be overlooked.

Often, even when users input a syntactically correct query, the concepts that they are searching for are not uniquely identified by the terms or group of terms in the search query. Because the user can only input one query at a time, there is a need to try to satisfy the user's intent without requiring that the user enumerate all the queries that reflect this particular intent.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figure of the accompanying drawings and in which like reference numerals refer to similar elements and in which:

FIG. 1 is a flow diagram that provides an overview of constructing a dictionary of similar phrases.

FIG. 2 is a flow diagram that illustrates how a similarity score is generated for a web corpus.

FIG. 3 shows an example of analyzing a document to determine document similarity using 4-grams.

FIG. 4 is shows an example of computing the word frequency of a phrase based on the example of FIG. 3.

FIG. 5 is an example matrix showing the similarity of phrases used to construct the phrase similarity table.

FIG. 6 is an example phrase similarity dictionary corresponding to the example in FIG. 5.

FIG. 7 is a flow diagram showing the steps for processing an incoming query.

FIG. 8 is a block diagram of a computer system on which embodiments of the invention may be implemented.

### DETAILED DESCRIPTION

### Terminology

Many terms are closely related and sometimes used interchangeably or in different contexts. The web corpus is a very large set of web pages used as a representative sample of all web pages. The assumption is that conclusions drawn based on the contents of the web corpus should generalize to other web pages as well. A word is a single English word. Documents in the web corpus are comprised of individual words.

A search query is entered by the user wanting to find web pages related to the concepts specified in the query. Concept types are categories of meaning and provide an indication of the kind of information for which the user is searching. Thus, concept refers to what the user directly specified in the query and concept type a classification or abstraction of what the user typed. Thus, both concept and concept type are user-centric terminology.

When an incoming search query is analyzed, it is automatically broken down into segments. A segment is a sequence of words. The goal of query analysis is to identify those segments that identify a single concept to the user. These segments are called query terms, abbreviated to terms. During query analysis, as segmentation is performed and terms are identified, each term is assigned a semantic tag, abbreviated to tag, which is a representation of the concept type best suited to the query term.

Query terms are alternatively called phrases to emphasize the fact that terms may comprise multiple words. Thus, term and phrase are used interchangeably in this specification. Individual words provide context for similarity analysis. A phrase is in the context of a word if the phrase is found near a word in a document. An N-gram is a sequence of N contiguous words, where the length of the sequence is N number of words. Thus a four-gram is a sequence of four contiguous words. A phrase is considered near a word if an N-gram contains both the phrase and the word.

Drifting refers to the fact that expanding a query with a similar term moves or changes the meaning of the original query to be more precise and inclusive for obtaining the user's desired result. In other words, similar words are not necessarily synonyms. The dictionary is not merely a thesaurus. For example, “medical center” is not a synonym for “hospital.” “hospital” and “medical center” mean different things, but they are related, similar terms. A user interested in finding urgent care might search for “hospital,” but the search results are more complete if “medical center” is also a search term in the query. Thus the original query for “hospital” would drift to also include searching for “medical center.” Drifting is synonymous with “expanding the query.”

### Overview

The purpose of this invention is to satisfy the user's search result intent more accurately without requiring the user to enumerate all possible queries which reflect this intent. The user simply issues one query. The search engine expands the query to the similar concepts.

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

According to one embodiment of the invention, a search query (e.g., a set of one or more search terms) is broken down into constituent concepts, and the search query is modified such that only the concepts which should be augmented with similar concepts are augmented, and the concepts that should not be augmented are held static. The concepts that should be augmented are those that, when augmented, increase the relevance of the search results. For example, “schools” can be augmented by “education,” and “artificial flowers” can be augmented by the inclusion of “artificial plants” in order to increase relevance of search results. The concepts that should not be augmented are those that, when augmented, no not increase the relevance of the search results. For example, a proper name such as “San Jose” should not be augmented to “city” or “Mountain View” because the user is interested in that particular city, not any city, and not some other city. It has been empirically shown that, in general, augmentation of proper names degrades the relevance of the search results.

According to one embodiment of the invention, concepts in the user query are identified using Hidden Markov Model analysis. The most similar concepts are introduced in an expanded version of a user's query. In this way, the accuracy and completeness of recall from a search engine is greatly increased without much loss in precision.

### Offline Dictionary Construction Overview

A dictionary of similar terms is used when looking for a semantically similar term to use for augmenting a query. The dictionary is constructed offline using a controlled set of representative web pages (also called the “web corpus”) and query logs.

Historical query logs, i.e., records of search queries made over time in the past, are analyzed to extract commonly requested query terms, also called “phrases.” A term or phrase can comprise multiple words which together embody a single concept. These common phrases are the building blocks for the dictionary. For example, “San Jose” is two words, but comprises a single phrase which is the proper name for a city.

The web corpus is analyzed to find the contexts of the commonly used phrases within the documents. The context of a phrase is a group of contiguous words that include the phrase. Two phrases are considered similar if they share a context. One way to measure the similarity of two phrases is to look at the frequency of words common to the contexts of two phrases. Details of a similarity scoring procedure are provided below.

The output of analyzing the shared contexts of phrases within the web corpus populates the values of a matrix of all phrases, wherein for two phrases, the contents of the cell in the matrix is a similarity measure. Separate matrices are constructed to record three different similarity scores: document similarity, query similarity, and a translation score, each of which will be described in detail in the following sections. The three scores are combined into a single, overall similarity score, which is used for populating the dictionary.

### Determining Phrase Similarity

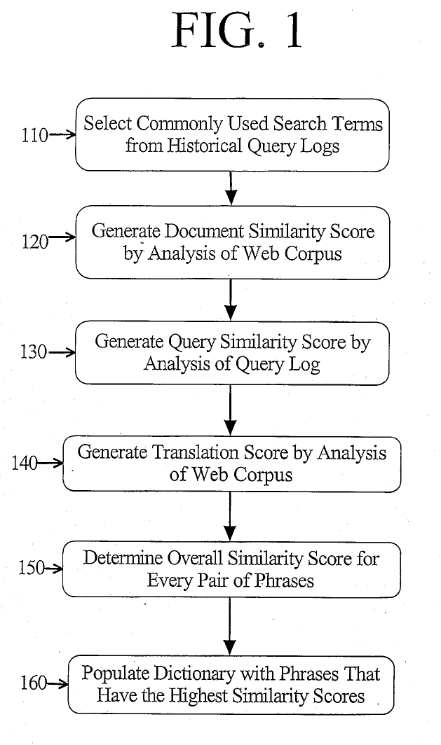

Computing the distributed similarity score for two phrases involves several steps as shown in FIG. 1. As described earlier, the first step is to determine the set of phrases to place in the dictionary. Historical query logs are mined for terms for which users commonly search. The most popular terms are selected for the dictionary (Step 110). The web corpus is analyzed to produce a document similarity score in Step 120, and the process is repeated to generate a query similarity score based on the query log (Step 130). In Step 140, a translation score is calculated based on the co-location of similar terms within the same document in the web corpus. An overall similarity score is computed based on the document similarity, query similarity, and translation scores for every pair of phrases in the dictionary (Step 150). For each dictionary entry, the phrases with the highest similarity score to the entry are chosen to be listed as the terms that are similar to the entry (Step 160).

### Determining the Document Phrase Similarity Score

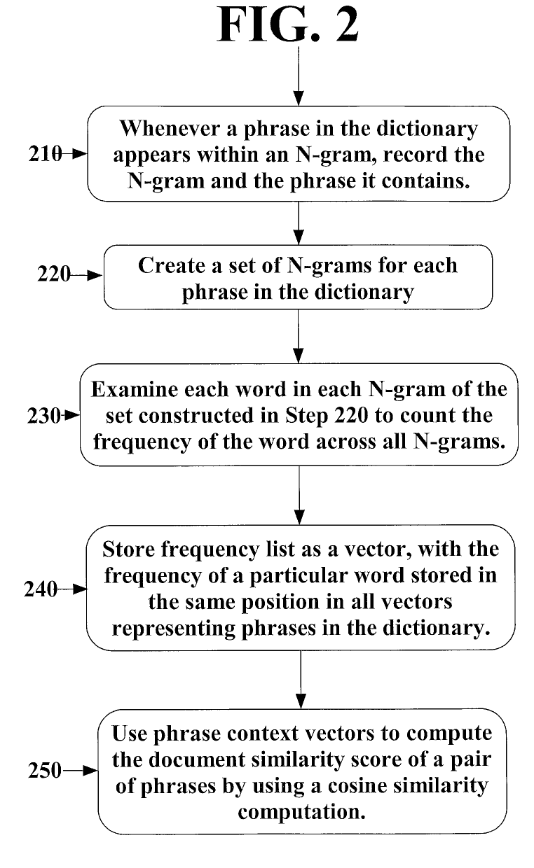

To calculate the document similarity, the web corpus is automatically analyzed one document at a time as shown in the flow diagram of FIG. 2. At Step 210, each document is analyzed sequentially, starting at the beginning with a sliding window of a configurable size called an “N-gram,” where N is the number of words in the sliding window. In one embodiment, the size of the sliding window is configured to be four words, and a four-gram is used for analysis. In an alternative embodiment, a sliding window of other lengths may be used. However, the length of a phrase in the dictionary may not exceed the length of the sliding window. Whenever a phrase in the dictionary appears within the N-gram, the N-gram and the phrase it contains are recorded. The window slides to the next word, and the process repeats until an entire document has been analyzed. All documents in the web corpus are analyzed in this same way.

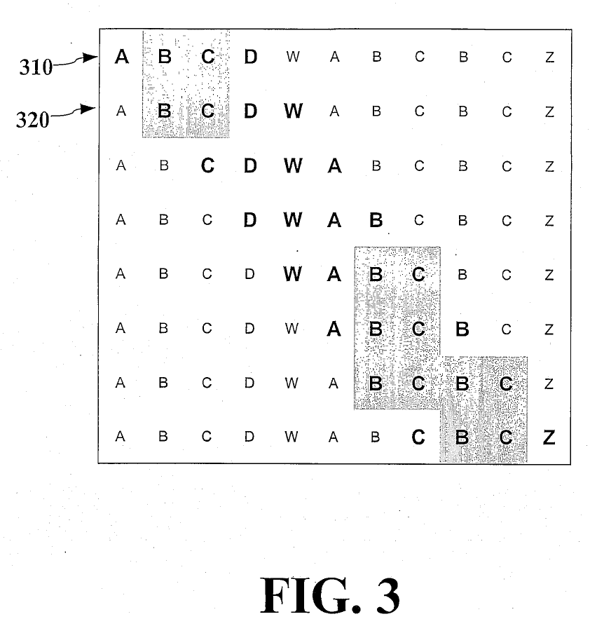

At Step 220, a set of N-grams is created for each phrase in the dictionary where all the N-grams in the set contain the phrase. Each unique N-gram appears in the set once with a frequency associated with that N-gram. That is, if an identical N-gram is recorded M times in Step 220, then that particular N-gram is added to the set of unique N-grams once with a frequency of M. FIG. 3 shows an example of identifying a set of four-grams in a document containing a phrase. In this example, each letter represents a distinct word. Each line represents examining a particular four-gram in a sequence of words. The four-gram appears in bold type. In this example, context for the 2-word phrase “BC” is being assembled, and “BC” is highlighted wherever it is found in a four-gram. Line 310 shows the line “ABCDWABCBCZ” where the four-gram under analysis is “ABCD.” Line 320 shows the window has slid to the right one word position to examine the four-gram “BCDW.” The set of four-grams containing the phrase “BC” in this example are: {ABCD, BCDW, WABC, ABCB, BCBC, and CBCZ}.

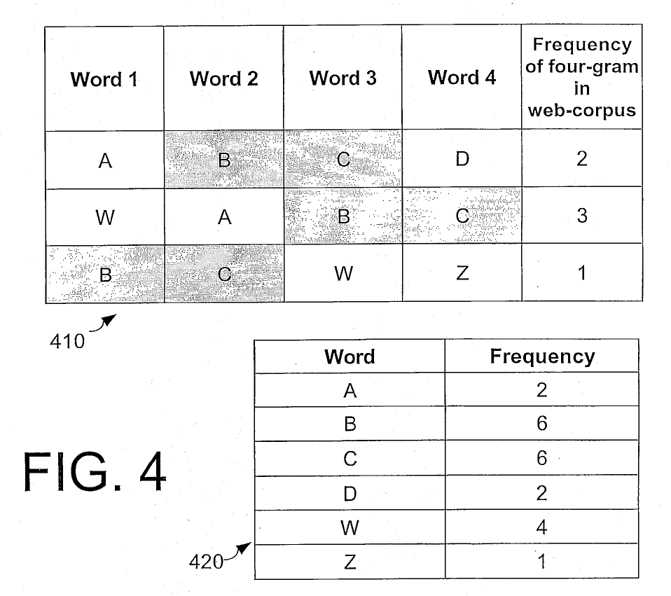

In Step 230, each word in each N-gram of the set constructed in Step 220 is examined to count the frequency of the word across all N-grams. FIG. 4 shows an example of how to compute the word frequency for “BC” in a different document than the one used in FIG. 3. Table 410 contains a portion of the set of unique four-grams found in the web corpus along with the number of times that unique four-gram was found. The phrase “BC” occurs in all four-grams of the set, although the phrase may appear in different positions within the four-gram. Table 420 is the word frequency table of the words that appear in Table 410. The frequency for each word is the sum of the frequencies of all of the four grams containing the word. For example, word A only appears in the first four-gram that was found twice in the web corpus, so its frequency is 2. However, B and C appear in all four-grams, and thus their frequency is the sum of the frequencies of all four-grams in the set: 2+3+1=6.

In Step 240, the word frequency list is stored as a vector, and the frequency of a particular word is stored in the same position in all vectors representing phrases in the dictionary. In one embodiment, a hash table is used with the word as the key, and the frequency as the value. The same hash function is used to create the vectors for all phrases. In an alternative embodiment, the vector is a simple array with words stored in alphabetical order. Other embodiments may use other data structures, provided that given a word, the frequency with respect to different phrases can be found in the same relative location within each of the phrase context vectors.

The phrase context vectors are used to compute the document similarity score of a pair of phrases by using a cosine similarity computation in Step 250. The cosine similarity score is computed as follows:

$$document similarity score = {\sum }_{i = 1}^{n} {v}_{1} ( i ) * {v}_{2} ( i )$$

The document similarity score for two phrases p₁ and p₂, represented by context vectors v₁ and v_{2,} is the inner product of the two vectors. In the formula, n is the number of distinct words represented in each phrase context vector, and v(i) is the frequency of the ith word stored in the vector. If a word is in the context for one phrase but not the other phrase, then the word's frequency is 0 for the phrase in which the word does not appear, and thus will not contribute to the total.

### Determining the Query Term Similarity Score

The query similarity score is based on an analysis of shared context of phrases within historical query logs, rather than an analysis of the web corpus. In one embodiment, the method for computing the query similarity score is identical to the method of computing the document similarity score described above. However, analysis on the query log can be slightly different because queries are typically short in comparison to a document. Because there is less context that can be used for analysis in a short web query, an alternative embodiment evaluates the similarity of the tags assigned to the query terms rather than the terms themselves. This technique serves to reduce the sparseness of the vectors by modifying the method as follows. First, rather than employing an N-gram to establish context, the historical queries are segmented into one or more terms, and each term is assigned a tag. This is the same process that is used for incoming user queries. The process is described in more detail below. The tags assigned to the historical query terms, rather than individual words, are used as context. For certain tags, the query terms in an historical query are replaced by the tag that represents the term. For example, if the tag “city name” is selected as one of the tags to replace for reducing sparseness, then if one query is “schools in San Jose” and another query is “schools in Mountain View”, replacing the tag for the proper name would result in new queries, “schools in <city name>” for both queries. Thus, rather than storing “San Jose” and “Mountain View” as independent context with each term having frequency 1, the term <city name> would be used instead, and assigned a frequency of 2. Once the historical queries are transformed in this way, vectors are constructed based on the query terms, and the inner product of the vectors is computed in the same way as above for each pair of phrases.

In one embodiment, all tags replace their corresponding query terms. In an alternate embodiment, a proper subset of tags is selected for replacing the tags' corresponding query terms.

### Determining Translation Score

The Translation Score is a simple determination of how many times two phrases occur within the same document, without regard to how close those phrases are in proximity. The translation score is the number of documents in which the two phrases exist divided by the product of the number of documents in which one phrase appears and the number of documents in which the other phrase appears. For example, if the two phrases are represented by p₁, and p₂, then

$$ts = \frac{( \# documents containing {p}_{1} and {p}_{2} )}{( \# documents containing {p}_{1} ) * ( \# documents containing {p}_{2} )} .$$

### Determining an Overall Similarity Score

The overall similarity score between two phrases is a linear combination of the three scores described above: document similarity score (ds), query similarity score (qs) and translation score (ts). The formula is:

Similarity(p1, p2)=a*ds+b*qs+c*ts

where p₁ and p₂ are two phrases, and a, b, and c are constants determined by experimentation to generate a similarity score, which when used, produce the most relevant search results.

### Creating the Dictionary

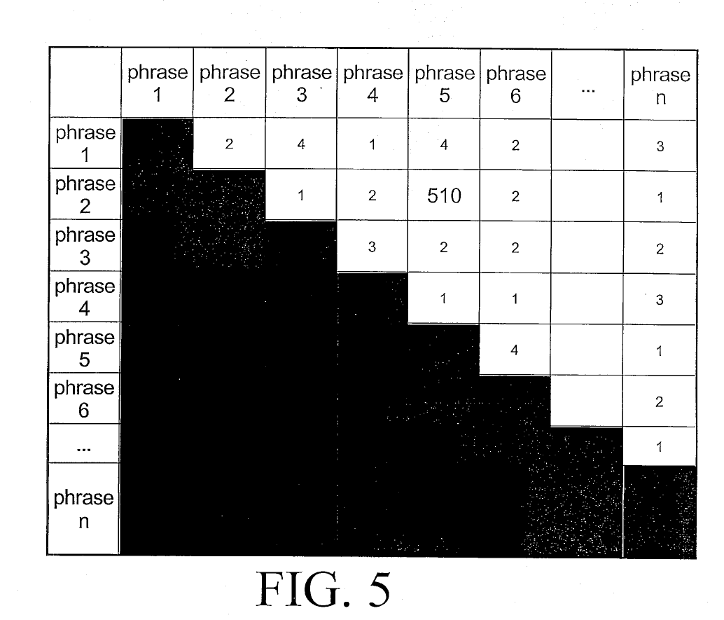

Creating the dictionary is a two-step process. First, a 2 -dimensional matrix is created with dictionary phrases as both dimensions. FIG. 5 shows an example of such a matrix. For any two distinct phrases, their overall similarity score is stored in the matrix cell at their intersection (cell 510). In one embodiment, less than half the matrix is filled out because there is no need to fill in cells on the diagonal (e.g., cells representing the similarity of a phrase with itself). Also, the order of the phrases does not matter; thus, the similarity of (p₁, p₂)=similarity of (p₂, p₁). Therefore, the similarity of p₁ and p₂ need only be stored once in the matrix.

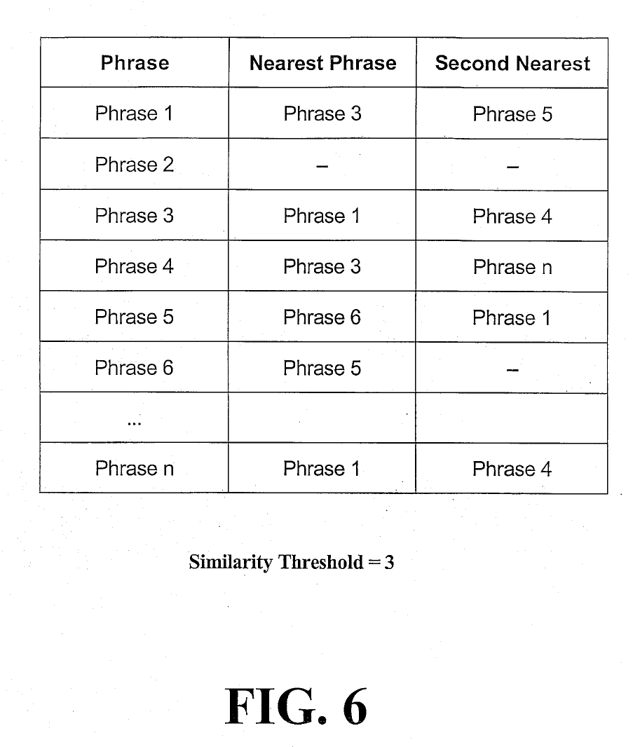

In the final step, for each dictionary entry (representing a phrase), the similarity scores for all phrase pairs containing the dictionary entry are found in the matrix. Some number of phrases with the highest similarity values to the dictionary entry are placed in the dictionary in association with the dictionary entry. In other words, when the entry is looked up, the phrases returned are those with the highest similarity scores. In one embodiment, the phases with the 3 highest similarity values are selected for inclusion. FIG. 6 shows an example of an alternative embodiment in which the dictionary, constructed using the example similarity scores shown in FIG. 5, stores the 2 highest similarity values. For example, when selecting the phrases most similar to Phrase 1, the highest similarity score is 4 corresponding to both Phase 3 and Phrase 5. Thus, Phrase 3 and Phrase 5 are added to the dictionary as the terms most similar to Phrase 1. The example in FIG. 6. also shows an embodiment in which a minimum similarity threshold is applied. For some phrases, such as Phrase 2, none of the other phrases are sufficiently similar to warrant expanding a query with those other phrases, even if the tag of Phrase 2 is expandable. In this example, the similarity threshold is set at 3, but a score of 2 is the maximum similarity score of any phrase with Phrase 2. Likewise, for Phrase 6, only Phrase 5 (with a similarity score of 4) is sufficiently similar to warrant using Phrase 5 in an expanded search query. The second highest similarity of any other phrase with Phrase 6 is 2, which does not exceed the minimum threshold of 3.

### Overview of Processing an Incoming Query

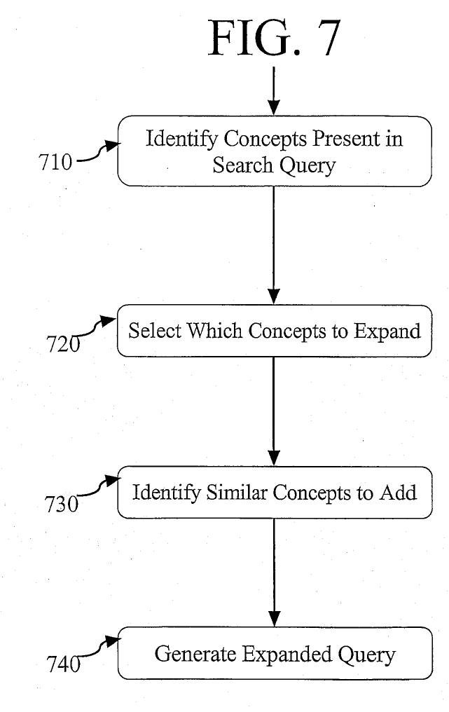

When a user submits a search query, processing the query comprises several steps as shown in FIG. 7. The first step is to parse the user-submitted query into segments which correspond to concepts ( 710). This is performed using predictive sequential analysis, techniques of which are commonly known in the art. As an example, the search query may be: ‘San Jose restaurants.’ In this case, two different concepts would be identified: ‘San Jose’ and ‘restaurants.’ Once the beginning and end points of the segments present in the query are determined, the segments are classified according to their type.

Once the concepts in the query have been identified and tagged with concept types, terms within the query are selected for expansion based on the concept type assigned to those terms. Some concept types are expandable and others are not. A list of the query terms with assigned expandable concept types are collected in Step 720.

In Step 730, the list of terms collected in Step 720 are looked up in the dictionary of similar terms, and one or more of the similar phrases for each term in the list is selected for expanding the query. Finally, the query is expanded by adding the selected similar phrases as additional search terms which are treated as equivalent to the original search terms by the search engine. The search engine treats equivalent terms as though they were the same phrase for ranking purposes. More detail about these steps is given below.

### Identifying Concepts within the Query

After a user enters a search query, the query is parsed into one or more segments, with each segment comprised of a phrase representing a concept. Each phrase is analyzed to determine which semantic tag to assign to that phrase (stated in other words, the phrase is classified according to one of the concept types known to the system). This analysis is conducted using one of a set of well-known sequence tagging algorithms such as Hidden Markov Models (HMM) or the Max Entropy Model. The sequence tagging algorithm takes a sequence of query segments as input and, based on the model, generates a sequence of semantic tags, where the number of generated semantic tags is the same as the number of query segments in the input sequence.

Before any queries can be automatically tagged, an offline process is employed to build the model. In one embodiment, a HMM is used. Sample representative queries are analyzed by an automated, rule-driven process or alternatively by a human editor to perform segmentation and determine a semantic tag to assign each phrase in each sample query. Once constructed, this “training data” is automatically analyzed to construct a set of matrices containing the observational and transitional probabilities, as described next.

Observational probability considers the probability of a particular tag being assigned to a particular phrase in the sequence of tags in the query. Observational probability is calculated as the frequency of assigning a particular tag t to a particular phrase p, divided by the frequency of tag t assigned to any phrase:

$$\frac{f ( p , t )}{f ( t )} .$$

An observed probability matrix is created to store the values computed by this formula. One dimension of the matrix is all the different phrases found in the training data, and the other dimension is all the different semantic tag types. Given a phrase and a tag, the matrix is used to look up the observational probability of assigning the tag to the phrase.

Transitional probability is the probability that a tag tᵢ will follow a sequence of tags {tᵢ₋₂, tᵢ₋₁} in a tag sequence. A matrix is created in which one dimension includes all the different individual semantic tags, and the other dimension is every combination of two semantic tags that could precede a tag. The entries of the matrix store the probability of seeing a sequence {tᵢ₋₂, tᵢ₋₁, tᵢ} across all positions i in the queries of the training data:

$$Transitional probability = \frac{\# times sequence ( {t}_{i - 2} , {t}_{i - 1} , {t}_{i} ) observed}{\# times sequence ( {t}_{i - 2} , {t}_{i - 1} ) observed}$$

In order to use the transitional probability formula in the above example, implicit ‘START’ and ‘END’ tags are added to the query sequence. Thus, a tag sequence of tags A,B,C, and D is treated as “‘START’ A B C D ‘END’.” The probability of finding “A” at the start of the sequence translates to the formula:

$$\frac{f ( START , A )}{f ( START )} ,$$

where f stands for the number of occurrences, or frequency, of observing the sequence. Thus f(START, A) represents the number of times “A” appears at the beginning of a sequence, and f(START) is the number of sequences analyzed (as all sequences have an implicit START tag). The probability of finding the sequence “BCD” anywhere in the sequence is calculated as:

$$\frac{f ( B , C , D )}{f ( B , C )} ,$$

where f(B,D,C) is the number of times the sequence “BCD” is found and f(B,C) is the number of times the sequence “BC” is found at any position within the sequences of training data. The probability of finding “CD” at the end of the sequence is computed as:

$$\frac{f ( C , D , END )}{f ( C , D )} ,$$

where f(C,D,END) is the number of times the sequence “CD” is found at the end of a sequence, and f(C,D) is the number of times the sequence “CD” is found anywhere in a sequence.

The transitional probability reflects the probability of a particular sequence of tags based on the frequency of the particular sequence of tags found in the training data (independent of the content of the current query). The observational probability, in contrast, considers the specific phrases in the current query. The likelihood of a particular tag sequence of length l matching the current query is computed as the transitional probability multiplied by the observational probability. Thus, the formula for the likelihood of a query containing a sequence of words phrases being assigned a sequence of tags is:

$${\prod }_{i = 1}^{l} \frac{f ( {p}_{i} , {t}_{i} )}{f ( t )} * \frac{f ( {t}_{i - 2} , {t}_{i - 1} , {t}_{i} )}{f ( {tk}_{i - 2} , {tk}_{i - 1} )}$$

where l is the number of phrases in the query, with each phrase pᵢ being assigned a semantic tag tᵢ, and (tᵢ₋₂, tᵢ₋₁) is a tag sequence preceding tag tᵢ.

Here is an example of applying the above formula for a query of length 4, computing the likelihood of a tag sequence “A B C D” matching a query sequence of “cat dog bird hamster.” The likelihood L is the product of all the rows in the following table:

| English description | Formula |
|---|---|
| probability of finding “A” at the start of the sequence | $\frac{f ( START , A )}{f ( START )}$ |
| probability of finding “AB” at the start of a sequence among the sequences that start with A. | $\frac{f ( Start , A , B )}{f ( Start , A )}$ |
| probability of finding “ABC” anywhere in a sequence among the sequences that contain “AB” | $\frac{f ( A , B , C )}{f ( A , B )}$ |
| probability of dinging “BCD” anywhere in a sequence among the sequences that contain “BC” | $\frac{f ( B , C , D )}{f ( B , C )}$ |
| probability of finding “CD” at the end of a sequence among the sequences that contain “CD” | $\frac{f ( C , D , END )}{f ( C , D )}$ |
| probability that “cat” was tagged with “A” among sequences that contain a tag “A” | $\frac{f ( “ cat ” , A )}{f ( A )}$ |
| probability that “dog” was tagged with “B” among sequences that contain a tag “B” | $\frac{f ( “ dog ” , B )}{f ( B )}$ |
| probability that “bird” was tagged with “C” among sequences that contain a tag “C” | $\frac{f ( “ bird ” , C )}{f ( C )}$ |
| probability that “hamster” was tagged with “D” among sequences that contain a tag “D” | $\frac{f ( “ hamster ” , D )}{f ( D )}$ |

This same process is carried out for all possible tag sequences (in this example, sequences of length 4), and the tag sequence with the highest L value is the correct sequence to assign the current query, where the phrase in the input sequence is assigned or “tagged with” the semantic tag in the corresponding position of the output sequence. For example, for the input sequence {“cat”, “dog”, “bird”, “hamster”} and an output sequence {A, B, C, D}, “cat” is tagged with A, “dog” is tagged with B, “bird” is tagged with C, and “hamster” is tagged with D.

### Selecting which Query Terms to Expand

After the query has been broken down into its constituent concepts, a determination is made for each concept whether terms similar to the concept should be added to the query to enhance the relevance of the search results. The determination is based on the type of concept. Empirical studies have shown which concept types contribute to a more complete search when the concepts are augmented with similar terms. Examples of concept types that are known to improve relevance when expanded in a query include business category and product category. These studies have also demonstrated that certain concept types fail to enhance the quality of the search results when expanded, and might actually diminish the quality when expanded. For these non-expandable concepts, no similar terms are added to the query.

As an example, the classification process might indicate that the segment is a location, business name, business category, or a product category. A short query may contain only one concept, but a longer query might have multiple concepts. Empirically gathered data has shown that when similar terms for user-specified business categories or product categories are added to the query, the results are enhanced. However, user-entered proper names, locations, or business names do not produce helpful results when augmented with similar terms. For example, a query including the concept ‘restaurant’ would yield better results if a similar concept ‘diner’ were added to the query. However, adding ‘Philadelphia’ to a query including the concept ‘San Jose’ would not be helpful. A user interested in businesses in San Jose, is not likely to be interested in business in Philadelphia if the user expressly entered “San Jose.”

### Selecting Similar Terms for Query Expansion

Once the query is partitioned into terms to be expanded and terms not to be expanded, one or more of the terms to be expanded are looked up in the dictionary to retrieve one or more similar terms. In one embodiment, the query is augmented with similar terms for all of the expandable terms.

### Generating an Expanded Search Query

A new query including all the original search terms and the additional similar terms is generated. The new query is expressed in an internal query execution language executed by the search engine. Using the above example query, “Restaurants in San Jose,” the search engine would protect the term “San Jose” because it is a location. The search engine would augment the query to introduce terms similar to the concept ‘restaurants.’ The search engine may determine that the words ‘deli’ and ‘diner’ are contextually similar to ‘restaurant.’ In this case, the resulting search query may be: (Restaurants or diner or deli) and “San Jose.”

The additional terms are searched for along with the original terms as though the user had originally typed the additional terms in the search query. However, rather than treating the additional terms as separate query terms when ranking search results, the search engine treats each additional term as equivalent to the original expandable term to which it is similar. For example, ‘diner’ is treated as equivalent to ‘restaurant.’ Within a document, all instances of both ‘diner’ and ‘restaurant’ are found, but their frequencies are added together for purposes of ranking the document in the search results. Thus, if ‘diner’ is found twice in a document, and ‘restaurant’ is found three times in the same document, ‘restaurant’ will be treated as though it occurred five times in the document for purposes of scoring the document. In contrast, if the user had entered ‘restaurant’ and ‘diner’ in the original search query, the ranking function would use a frequency of three for ‘restaurant’, and a frequency of two for ‘diner.’ Depending on the rank scoring function in use, this equivalence between original and similar terms can alter the outcome of the search result ranking.

### Hardware Overview

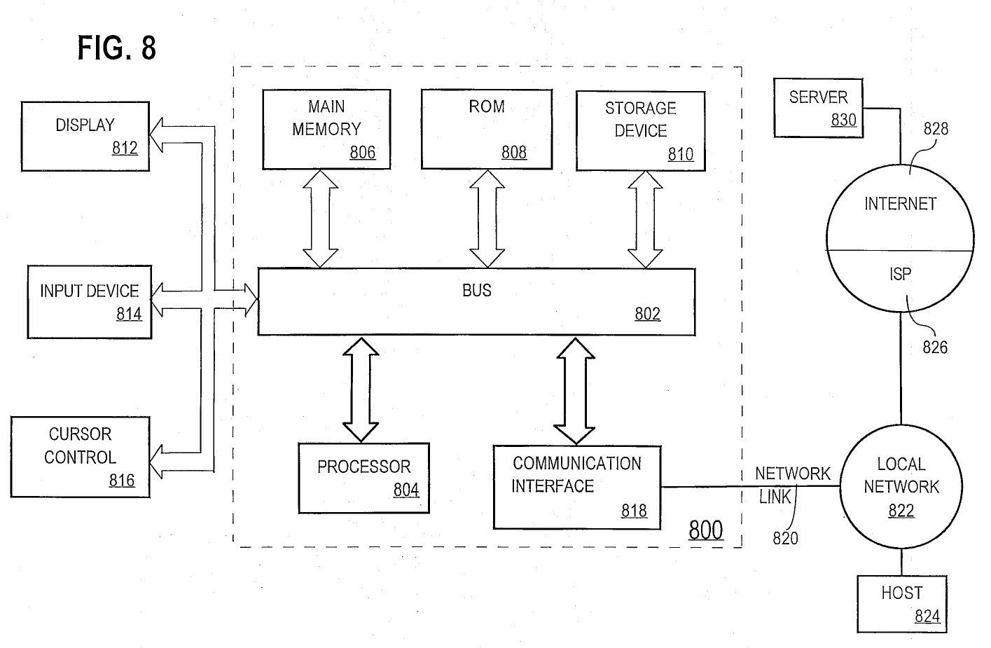

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 800, various machine-readable media are involved, for example, in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
receiving a search query comprising one or more search terms from a user;
for each search term of the one or more search terms, performing particular steps to form an expanded search query;
issuing said expanded search query to a search engine; and
storing, in a volatile or non-volatile computer memory, search results received in response to said expanded search query;
wherein said particular steps comprise:
determining which particular tag of a plurality of tags to assign to said each search term;
determining, based on the particular tag assigned to said each search term, whether to expand the search query;
in response to determining to expand the search query, selecting one or more particular search terms based on said each search term; and
adding said one or more particular search terms to the search query to form said expanded search query.

2. The method of claim 1, wherein the particular tag assigned to said each search term is based on a concept type of said each search term, wherein the concept type is an indication of a kind of information for which the user is searching.

3. The method of claim 1, wherein the step of determining, based on the particular tag assigned to said each search term further comprises looking for the particular tag in a certain subset of the plurality of tags, wherein the certain subset:
(a) only includes tags which are known to improve relevance of the search results when the search query is expanded with search terms similar to said each search term; and
(b) does not include tags which are known to not improve the relevance of the search results when the search query is expanded with search terms similar to said each search term.

4. The method of claim 1, wherein the plurality of tags includes at least one of location, business name, business category, or product category.

5. The method of claim 3, wherein the certain subset of the plurality of tags known to improve the relevance of the search results includes at least one of business category and product category.

6. The method of claim 1, wherein the step of selecting one or more particular search based on said each search term comprises:
for each particular search term of the one or more particular search terms:
(a) a similarity value is associated with said each particular search term;
(b) said each particular search term is selected in order of greatest similarity value; and
(c) the similarity value associated with said each particular search term exceeds a threshold.

7. The method of claim 1, wherein the step of determining which particular tag to assign is determined by using a sequential analysis model.

8. The method of claim 7, wherein the sequential analysis model is a Hidden Markov Model.

9. The method of claim 1, wherein issuing said expanded search query to a search engine further comprises:
specifying the equivalence of an original search term with a newly added corresponding similar term;
finding a first number of all occurrences of the original search term in a document of a collection of searchable documents;
finding a second number of all occurrences of the corresponding similar term in the document; and
determining a rank of the document based at least on a total number of occurrences of both terms, wherein the total number is the first number added to the second number.

10. The method of claim 1, wherein a plurality of additional search terms are selected and added to the search query to form said expanded search query.

11. The method of claim 1, wherein in response to determining not to expand the search query, based on the particular tag assigned to said each search term, issuing the search query without expanding the search query.

12. A method for constructing a dictionary of similar search terms comprising:
building a context vector for each term of the set of terms to be included in the dictionary;
storing the context vector in association with said each term;
for each unique pair of terms, computing a similarity value based on the context vectors stored in association with the terms of said each unique pair of terms; and
storing the similarity value in association with said each unique pair;
for each particular term in the set of terms, ranking a subset of pairs in order of their similarity value, wherein each pair in the subset of pairs contains said each particular term;
selecting one or more pairs of terms of said subset of pairs of terms in order of their similarity value, wherein the pair with the highest similarity value is selected first; and
placing the terms contained in the one or more pairs of selected terms in the dictionary in association with said each particular term.

13. The method of claim 12, wherein computing said similarity value for a pair of terms is based on a document similarity score, a query similarity score, and a translation score for said pair of terms.

14. The method of claim 13, wherein said document similarity score for said pair of terms is computed based on computing a cosine similarity function based on a first context vector and a second context vector wherein the first context vector is stored in association with a first term of said pair of terms and the second context vector is stored in association with a second term of said pair of terms.

15. The method of claim 12, wherein a context vector is constructed for a term by steps comprising:
collecting a set of unique N-grams across a collection of web documents,
wherein an N-gram is a set of some number of contiguous words in a document of the collection of documents;
wherein each N-gram added to the set of unique N-grams contains said term;
counting the frequency of said each N-gram found in said collection of documents;
for each word in each unique N-gram, computing a word frequency for said each word by adding the frequencies of certain N-grams in the set of unique N-grams, wherein said certain N-grams contain the word; and
storing the word frequency in the vector indexed by said each word;

16. The method of claim 13, wherein said query similarity score is computed based on computing a cosine similarity function of two context vectors, wherein each context vector represents a search term in the dictionary.

17. The method of claim 16, wherein a context vector is constructed for a term by steps comprising:
performing particular steps to transform a query in a set of queries to create a set of transformed queries;
for each distinct word occurring in any of the queries of the set of transformed queries, counting the frequency that said each distinct word appears; and
storing the word frequency in the vector indexed by the search term;
wherein performing the particular steps to transform each query comprises:
determining a tag to assign a search term in the search query;
determining, based on the tag assigned, whether to substitute the tag for the search term in the search query;
in response to determining to substitute the tag for the search term in the search query, replacing the search term with the tag assigned to the search term;

18. The method of claim 13, wherein the translation score for a pair of terms is computed based on the number of documents of the collection of documents that contain both terms of the pair of terms.

19. The method of claim 18, wherein the translation score for pair of term is computed by dividing the number of documents containing both terms of the pair of terms divided by the product of a first value and a second value, wherein the first value is the number of documents containing a first term of the pair of terms and the second value is the number of document containing a second term of the pair of terms, wherein the first term is different from the second term.
